(19) United States
(12) Patent Application Publication
(10) Pub. No.: US 2026/0219166 A1
(43) Pub. Date: Jul. 30, 2026

(54) CORROSION DETECTION FOR CARBON INJECTION WELLS USING A LOW-COST FLAT PACK

(71) Applicant: Halliburton Energy Services, Inc., Houston, TX (US)

(72) Inventors: Michael Fripp, Singapore (SG); Darrell Adkins, Stavanger (NO); Darren Barlow, Houston, TX (US); John Laureto Maida, Houston, TX (US)

(73) Assignee: Halliburton Energy Services, Inc., Houston, TX (US)

(21) Appl. No.: 19/038,950

(22) Filed: Jan. 28, 2025

(51) Int. Cl. G01N 17/04; E21B 47/00

(52) U.S. Cl. CPC G01N 17/04; E21B 47/006

(57) ABSTRACT

A downhole corrosion detection system may include at least one corrosion test wire configured to extend along a downhole tubular at least between a first axial position and a second axial position that is disposed downhole with respect to the first axial position. The at least one corrosion test wire is configured to transmit an electrical signal. The downhole corrosion detection system may further include an electrical insulator disposed between the at least one corrosion test wire and the downhole tubular to prevent electrical shorting between the at least one corrosion test wire and the downhole tubular. Additionally, the downhole corrosion detection system may include a measuring device configured to measure the ability of the at least one corrosion test wire to transmit the electrical signal to determine an amount of corrosion of the at least one corrosion test wire.

### BACKGROUND

After drilling a wellbore in a subterranean formation for recovering hydrocarbons such as oil and gas lying beneath the surface, a casing string may be fed into the wellbore. Generally, the casing string protects the wellbore from failure (e.g., collapse). Further, production tubing may be fed into the wellbore through the casing string. Hydrocarbons may be pumped to the surface via the production tubing and/or the casing string. Unfortunately, during production operations, downhole conditions may corrode the production tubing and/or the casing string, which may negatively affect production operations. Generally, logging tools may be run-in-hole to detect corrosion of the production tubing and/or the casing string. However, using logging tools to detect corrosion may be disruptive to production operations and expensive.

### BRIEF DESCRIPTION OF THE DRAWINGS

These drawings illustrate certain aspects of some of the embodiments of the present disclosure and should not be used to limit or define the method.

FIG. 1 illustrates an elevation view of a downhole corrosion detection system, in accordance with some embodiments of the present disclosure.

FIG. 2 illustrates an elevation view of a downhole corrosion detection system having a power source positioned downhole, in accordance with some embodiments of the present disclosure.

FIGS. 3A-B illustrate elevation views of a downhole corrosion detection system before corrosion and after corrosion, respectively, in accordance with some embodiments of the present disclosure.

FIG. 4 illustrates an elevation view of a downhole corrosion detection system having an electrical bus, in accordance with some embodiments of the present disclosure.

FIG. 5 illustrates an elevation view of a downhole corrosion detection system having a wire housing and protective covers, in accordance with some embodiments of the present disclosure.

FIG. 6 illustrates an elevation view of a downhole corrosion detection system having unique corrosion test wires, in accordance with some embodiments of the present disclosure.

FIG. 7 illustrates an elevation view of a downhole corrosion detection system having a combination of unique corrosion test wires and protective covers, in accordance with some embodiments of the present disclosure.

FIG. 8 illustrates an elevation view of a downhole corrosion detection system having an electrical bus with at least one reflector for a pulse reflection measurement, in accordance with some embodiments of the present disclosure.

FIG. 9 illustrates an elevation view of a downhole corrosion detection system with at least one ground plate disposed within a wire housing for a capacitance measurement, in accordance with some embodiments of the present disclosure.

### DETAILED DESCRIPTION

Disclosed herein are systems and methods for determining an amount of corrosion of a downhole tubular and, more particularly, example embodiments may include a corrosion detection system having at least one corrosion test wire extending at least partially along the downhole tubular. The at least one corrosion test wire and the downhole tubular may be formed from a similar or same type of material, such that the at least one corrosion test wire and the downhole tubular may corrode under similar downhole conditions. As set forth in greater detail below, corrosion of the at least one test wire may change the ability of the at least one corrosion test wire to transmit an electrical signal. As such, during completion operations, the corrosion detection system may determine an amount of corrosion of the downhole tubular based at least in part on detected changes in the ability of the at least one corrosion test wire to transmit electrical signals.

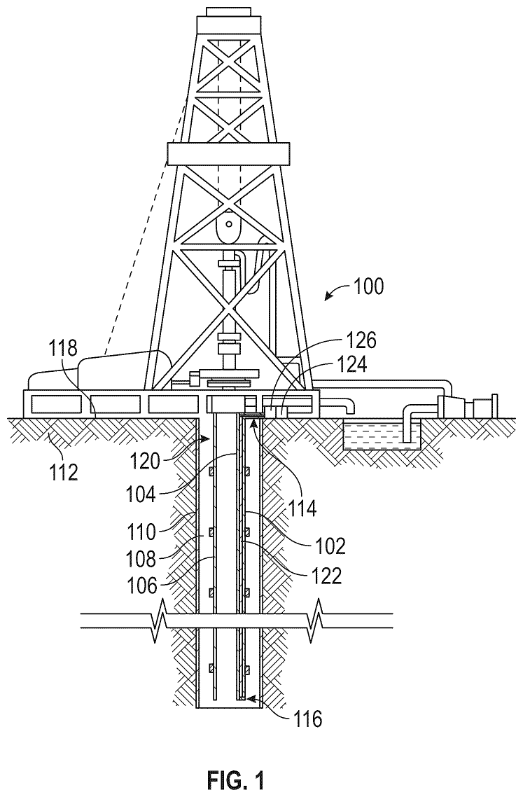

FIG. 1 illustrates an elevation view of a downhole corrosion detection system, in accordance with some embodiments of the present disclosure. The downhole corrosion detection system 100 may include at least one corrosion test wire 102 configured to extend along at least a portion of a downhole tubular 104. For example, the at least one corrosion test wire 102 may be configured to extend along at least a portion of a production tubing 106. The at least one corrosion test wire 102 may be disposed within an annulus 108 formed between the production tubing 106 and a casing 110. Alternatively, the at least one corrosion test wire 102 may be disposed radially outward from the casing 110, such that the at least one corrosion test wire 102 is disposed between the casing 110 and a downhole formation 112.

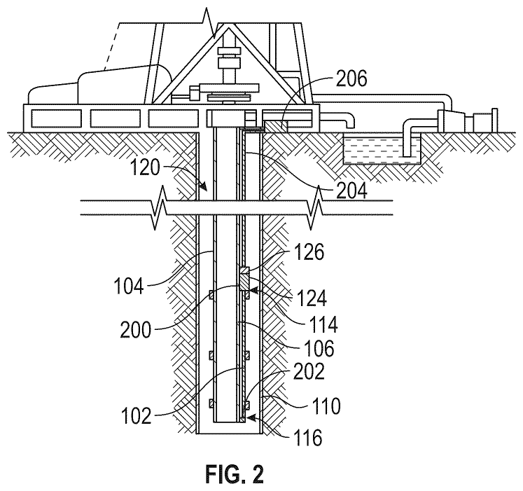

Further, the at least one corrosion test wire 102 is configured to extend along the downhole tubular 104 (e.g., the production tubing 106, the casing 110, etc.) between a first axial position 114 and a second axial position 116. As illustrated, the first axial position 114 may be located at a surface 118 of a borehole 120 (e.g., wellbore) and a second axial position 116 may be located downhole from the first axial position 114. Alternatively, the first axial position 114 may be disposed within the borehole 120 to reduce a length of the at least one corrosion test wire 102 (shown in FIG. 2). As set forth in greater detail below, the downhole corrosion detection system 100 is configured to determine corrosion of the downhole tubular 104 based at least in part on detected corrosion of the at least one corrosion test wire 102. As such, the at least one corrosion test wire 102 may be configured to extend at least along a portion of the downhole tubular 104 where corrosion monitoring is desired. For example, to monitor an entire length of the downhole tubular 104 for corrosion, the first axial position 114 may be disposed at the surface 118 and the second axial position may be disposed at or near a downhole end of the downhole tubular 104.

The downhole corrosion detection system 100 may further include an electrical insulator 122 disposed between the at least one corrosion test wire 102 and the downhole tubular 104 to help prevent electrical shorting between the at least one corrosion test wire 102 and the downhole tubular 104. That is, during operations, the at least one corrosion test wire 102 is configured to transmit an electrical signal output via a power source 124 of the downhole corrosion detection system 100. Further, the downhole corrosion detection system 100 may include a measuring device 126 configured to measure the ability of the at least one corrosion test wire 102 to transmit the electrical signal. Changes in the ability of the at least one corrosion test wire 102 to transmit the electrical signal may indicate corrosion of the at least one corrosion test wire 102, which may also indicate corrosion of the downhole tubular 104. Electrical shorting between the at least one corrosion test wire 102 and the downhole tubular 104 may provide false indications of changes in the ability of the at least one corrosion test wire 102 to transmit the electrical signal. However, having the electrical insulator 122 disposed between the at least one corrosion test wire 102 and the downhole tubular 104 may reduce or prevent electrical shorting between the at least one corrosion test wire 102 and the downhole tubular 104.

FIG. 2 illustrates an elevation view of a downhole corrosion detection system having a power source positioned downhole, in accordance with some embodiments of the present disclosure. A s set forth above, the at least one corrosion test wire 102 is configured to extend along the downhole tubular 104 (e.g., the production tubing 106, the casing 110, etc.) between the first axial position 114 and the second axial position 116. As illustrated, the first axial position 114 may be disposed within the borehole 120. Indeed, to monitor a specific length of the downhole tubular 104 for corrosion, the at least one corrosion test wire 102 may only be configured to extend along the specific length of the downhole tubular 104. As such, the first axial position may be disposed at an uphole end 200 of the specific length and the second axial position 116 may be disposed at a downhole end 202 of the specific length of the downhole tubular 104 to be monitored.

Moreover, the power source 124 and/or the measuring device 126 may be disposed at the surface 118 of the borehole 120. At least one connection wire 204 may extend between the at least one corrosion test wire 102 and the surface 118 to electrically couple the at least one corrosion test wire 102 to the power source 124 and/or the measuring device 126 at the surface. Alternatively, the power source 124 and/or the measuring device 126 may be disposed downhole proximate the first axial position 114. Any suitable communication device (e.g., wireline, mud pulse telemetry, etc.) may be used to communicate data from the downhole measuring device 126 to the surface (e.g., a surface controller 206).

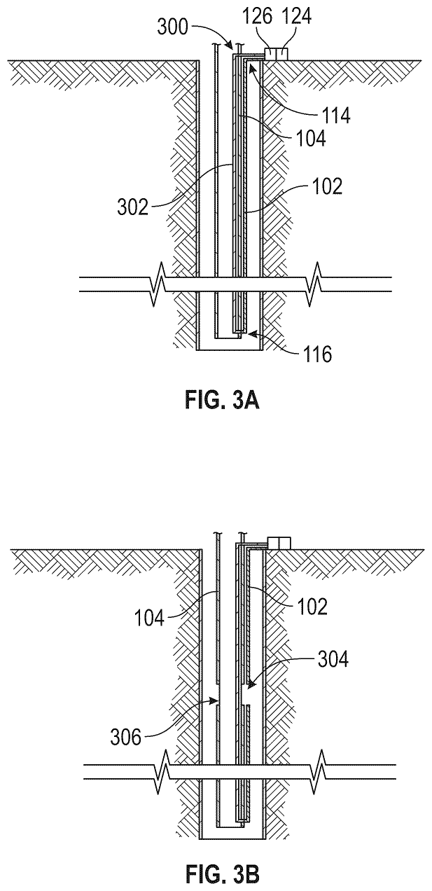

FIGS. 3A-B illustrate elevation views of a downhole corrosion detection system before corrosion and after corrosion, respectively, in accordance with some embodiments of the present disclosure. As set forth above, the at least one corrosion test wire 102 and the downhole tubular 104 may be formed from a similar or same type of material, such that the at least one corrosion test wire 102 and the downhole tubular 104 may corrode under similar downhole conditions. In particular, the at least one corrosion test wire 102 may include a metal material (e.g., steel, etc.) that matches a material corrosion rate of a downhole tubular material of the downhole tubular 104. For example, the at least one corrosion test wire 102 may be formed of the same type of steel used to form the downhole tubular 104 so that the material corrosion rates match because the material composition matches. As such the amount of corrosion of the at least one corrosion test wire 102 may be indicative of the amount of corrosion of the downhole tubular 104. That is, the at least one corrosion test wire 102 and the downhole tubular 104 may corrode at the same rate such that the amount of corrosion of the downhole tubular 104 can be determined based on the detected amount of corrosion of the at least one corrosion test wire 102. Further, the metal wire material of the at least one corrosion test wire 102 may be configured to match the tensile strength, grain size, heat treatment, electrochemical potential, and/or corrosion rate of the downhole tubular material of the downhole tubular 104, to further ensure that the amount of corrosion of the at least one corrosion test wire 102 is indicative of the amount of corrosion of the downhole tubular 104. By matching the tensile strength, grain size, heat treatment, electrochemical potential of the downhole tubular material of the downhole tubular 104, we mean that the two materials are within 50% of each other. By matching the corrosion rate of the downhole tubular material of the downhole tubular 104, we mean that the two materials will have rates of corrosion that are within 20% of each other when exposed to similar fluid and temperature conditions. By being indicative of the amount of corrosion, we mean that the rate of corrosion is within 20% of each other for one fluid at one temperature but may be different at other combinations of fluid and temperature.

Alternatively, the at least one corrosion test wire 102 may include a metal material (e.g., steel, etc.) that has a faster corrosion rate than the downhole tubular material of the downhole tubular 104. As such, the at least one corrosion test wire 102 may corrode at a faster rate than the downhole tubular 104 and can be used as a predictor for the onset of corrosion. In particular, the corrosion rate of the at least one corrosion test wire 102 may be 20% to 500% faster than the rate of corrosion in the downhole tubular 104. As such, during operations, the measuring device 126 may detect that the at least one corrosion test wire 102 is corroded, which may provide an indication that the downhole tubular 104 has not corroded but will soon be corroded.

Further, the at least one corrosion test wire 102 may include a metal material (e.g., steel, etc.) that has a slower corrosion rate than the downhole tubular material of the downhole tubular 104. In particular, the corrosion rate of the at least one corrosion test wire 102 may be 20% to 500% slower than the rate of corrosion in the downhole tubular 104. As such, the at least one corrosion test wire 102 may be configured to be thinner than the downhole tubular 104. For example, the at least one corrosion test wire 102 may include a thickness configured to fully corrode at a same or similar time as the downhole tubular 104. Since the at least one corrosion test wire 102 may include a slower corrosion rate than the downhole tubular 104, the at least one corrosion test wire 102 may be thinner than the downhole tubular 104.

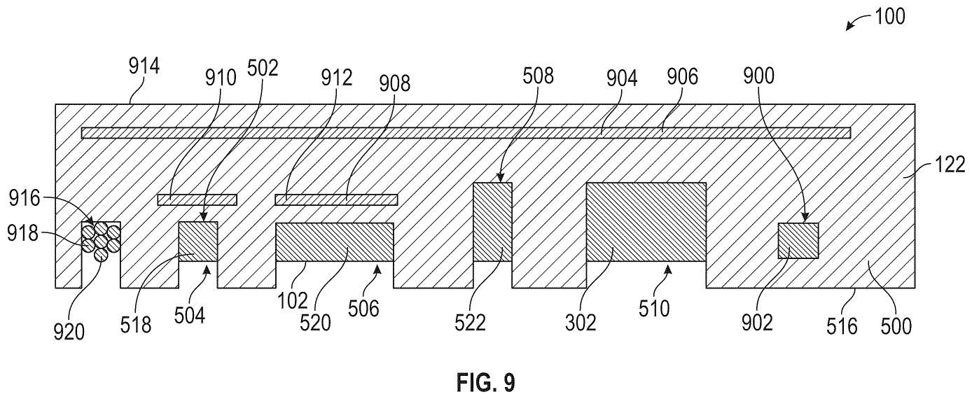

Moreover, the at least one corrosion test wire 102 may include a multi-strand wire 916 (shown in FIG. 9). Further, at least one strand of the multi-strand wire 916 may be different from other strands of the multi-strand wire 916. For example, the multi-strand wire 916 may include a first strand 918 that matches the corrosion of the downhole tubular 104 and a second strand 920 that is corrosion resistant (shown in FIG. 9). For example, the first strand 918 may be a carbon steel that matches the downhole tubular 104 and the second strand 920 may be a stainless steel that is corrosion resistant. Accordingly, the multi-strand wire 916 may only partially corrode under corrosive conditions such that there will be a change in the impedance for the multi-strand wire (e.g., based on the corrosion of the first strand 918), but the multi-strand will continue to provide electrical continuity to additional sections of the multi-strand wire via the second strand 920. The amount of corrosion of the multi-strand wire 916 may be determined based on the total change of impedance. Moreover, the multi-strand wire 916 may include different or additional strands having various types of material properties. For example, the multi-strand wire 916 may include strands having slower corrosion rates than the downhole tubular, faster corrosion rates than the downhole tubular 104, strands with varying sensitivities different corrosion products, etc.

FIG. 3A illustrates the at least one corrosion test wire 102 before corrosion. As set forth above, the amount of corrosion of the at least one corrosion test wire 102 may be indicative of the amount of corrosion of the downhole tubular 104. Further, as set forth above, the measuring device 126 is configured to measure changes in the ability of the at least one corrosion test wire 102 to transmit electrical signals to determine the amount of corrosion of the at least one corrosion test wire 102.

For example, as illustrated, the measuring device 126 may be configured to perform a resistance measurement to measure changes in the ability of the at least one corrosion test wire 102 to transmit electrical signals. In particular the power source 124 may be configured to apply the electrical signal (e.g., a voltage) at the first axial position 114. As illustrated, the at least one corrosion test wire 102 extending at least from the first axial position 114 to the second axial position 116 may form at least a portion of a circuit 300 of the downhole corrosion detection system 100. As set forth in greater detail below, the circuit 300 may further include a return line 302. The return line 302 may be on the interior of the tubular or in the same annular region as the corrosion test wire 102. The measuring device 126 may be configured to measure the resistance along any portion of the circuit 300 to measure the ability of the at least one corrosion test wire 102 to transmit electrical signals.

As illustrated, the measuring device 126 may detect a baseline resistance in response to the at least one corrosion test wire 102 having no corrosion. In response to partial corrosion of the at least one corrosion test wire 102, the resistance detected by the measuring device 126 may increase. That is, the cross-sectional thickness of a corroded portion of the at least one corrosion test wire 102 may decrease in response to the corrosion, which may increase the resistance detected by the measuring device 126. For example, the measuring device 126 may measure a resistance of fourteen ohms from the at least one corrosion test wire 102 having no corrosion. However, after corrosion, the measuring device 126 may measure a resistance of one-hundred and forty ohms from the at least one corrosion test wire 102. Moreover, an amount of corrosion of the at least one corrosion test wire 102 may be determined based on the amount of change in resistance measured by the measuring device 126.

FIG. 3B illustrates the at least one corrosion test wire 102 after corrosion. That is, the at least one corrosion test wire may include a corroded portion 304. Indeed, corrosion may continue to spread through the at least one corrosion test wire 102 until it breaks the at least one corrosion test wire 102. Current may fail to flow through the circuit 300 in response to the at least one corrosion test wire 102 breaking, which may be detected via the measuring device 126 and indicate that the downhole tubular also has corroded (i.e., includes a tubular corroded portion 306).

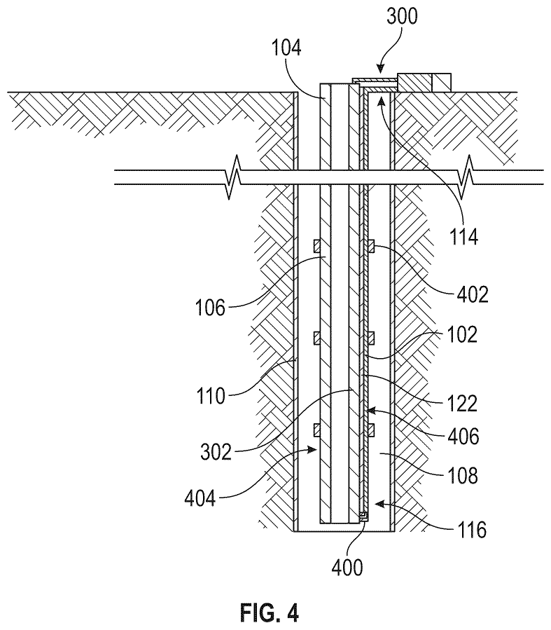

FIG. 4 illustrates an elevation view of a downhole corrosion detection system having an electrical bus, in accordance with some embodiments of the present disclosure. As set forth above, the at least one corrosion test wire 102 may extend along the downhole tubular 104 between the first axial position 114 and the second axial position 116 to form at least a portion of the circuit 300. Moreover, the downhole corrosion detection system 100 may further include an electrical bus 400 disposed at the second axial position 116. As illustrated, the at least one corrosion test wire 102 may be coupled to the electrical bus 400. Further, the electrical bus 400 may be electrically coupled to the downhole tubular 104 such that the downhole tubular 104 may operate as a return line 302 transmitting the electrical signal from the electrical bus 400 back to the first axial position 114. The measuring device 126 may be connected to both the downhole tubular 104 and the at least one corrosion test wire 102 at the first axial position 114 to complete the circuit 300. Alternatively, the at least one corrosion test wire 102 may be connected directly to the downhole tubular 104 at the first axial position 114, such that the measuring device 126 may be positioned at another portion of the circuit 300 to detect changes in the ability of the at least one corrosion test wire 102 to transmit electrical signals.

Further, as illustrated, the downhole corrosion detection system 100 may include the electrical insulator 122 disposed between the at least one corrosion test wire 102 and the downhole tubular 104 to help prevent electrical shorting between the at least one corrosion test wire 102 and the downhole tubular 104. The electrical insulator 122 may include an electrically insulative material such as polymer, rubber, ceramic, glass, or some combination thereof. Indeed, the electrical insulator 122 may include any suitable electrically insulative material. Further, the downhole corrosion detection system 100 may include at least one insulating clamp 402 configured to hold the at least one corrosion test wire 102 against the electrical insulator 122. For example, during operation, the at least one corrosion test wire 102 may be disposed in the annulus 108 between the production tubing 106 and the casing 110. The electrical insulator 122 may be secured to the radially outer surface 404 of the production tubing 106. To prevent the at least one corrosion test wire 102 from contacting the production tubing 106 and the casing 110, the insulating clamp 402 may hold the at least one corrosion test wire 102 against a radially outer surface 406 of the electrical insulator 122.

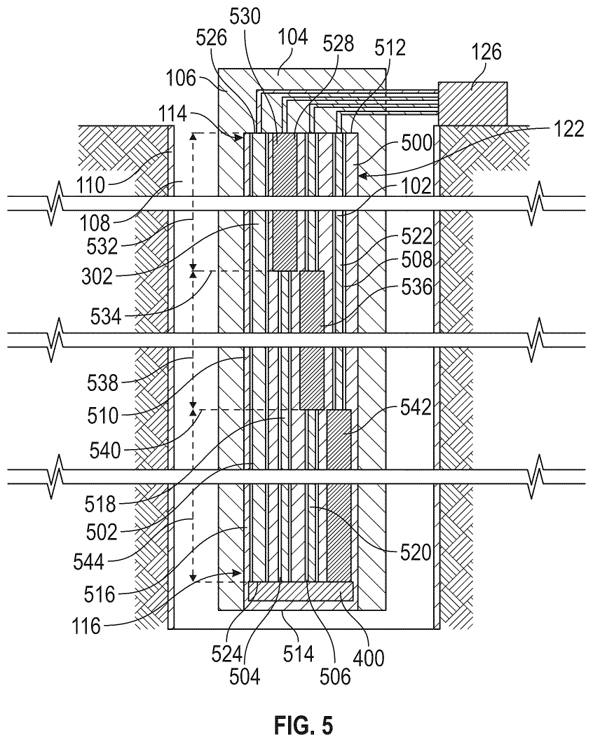

FIG. 5 illustrates an elevation view of a downhole corrosion detection system having a wire housing and protective covers, in accordance with some embodiments of the present disclosure. As illustrated, the electrical insulator 122 of the downhole corrosion detection system 100 may include a wire housing 500 having a plurality of recesses 502 (e.g., a first recess 504, a second recess 506, a third recess 508, a fourth recess 510, etc.) each configured to receive a corresponding corrosion test wire 102 or return line 302. Each recess of the plurality of recesses 502 may extend along the axial length of the electrical insulator 122 from an upper insulator end 512 of the electrical insulator 122 to a lower insulator end 514 of the electrical insulator 122. Alternatively, each recess of the plurality of recesses 502 may only extend along a portion of the axial length of the electrical insulator 122. Additionally, the plurality of recesses 502 may be spaced circumferentially about the wire housing 500 to separate the plurality of corrosion test wires 102, which may prevent electrical shorting between the plurality of corrosion test wires 102.

Further, the plurality of recesses 502 may be formed in a radially outer surface 516 of the wire housing 500 such that the plurality of recesses 502 may be exposed to downhole conditions about the downhole tubular 104. For example, the plurality of recesses 502 may be exposed to the annulus 108 formed between the production tubing 106 and the casing 110. Having the plurality of recesses 502 exposed to the annulus 108 may permit the downhole conditions to corrode the plurality of corrosion test wires 102 as the downhole conditions corrode the downhole tubular 104 such that the plurality of corrosion test wires 102 may provide an indication of the corrosion of the downhole tubular 104.

Moreover, as illustrated, the at least one corrosion test wire 102 may include a plurality of corrosion test wires 102 (e.g., a first corrosion test wire 518, a second corrosion test wire 520, a third corrosion test wire 522, etc.), which may be housed in corresponding recesses 502 of the wire housing 500. For example, the first recess 504 may be configured to receive the first corrosion test wire 518, the second recess 506 may be configured to receive the second corrosion test wire 520, and the third recess 508 may be configured to receive the third corrosion test wire 522. The downhole corrosion detection system 100 may further include the return line 302, which may be received within the fourth recess 510 of the wire housing 500. The return line 302 may be configured to extend along the downhole tubular 104 with a lower return line end 524 coupled to the electrical bus 400 and an upper return line end 526 coupled to the measuring device 126 or another suitable device proximate the first axial position 114. The return line 302 may be configured to transmit electrical signals between the electrical bus 400 and the first axial position 114 (e.g., the measuring device 126).

The downhole corrosion detection system 100 may further include a plurality of protective covers 528 configured to fit over one or more corresponding corrosion test wires 102 to protect the one or more corresponding corrosion test wires 102 from corrosion. In particular, the protective covers 528 may be secured to the radially outer surface 516 of the wire housing 500 to seal the corresponding recesses 502 from the annulus 108. Alternatively, the protective covers 528 may be formed in the wire housing 500. For example, portions of plurality of recesses 502 may extend through the wire housing 500 such that they are not exposed to the annulus 108. Further, the protective covers 528 may include a similar material to the insulative material of the wire housing 500. However, the protective covers 528 may include any suitable material for sealing the recesses 502 and corresponding corrosion test wires 102 from the annulus 108.

Moreover, as illustrated, each protective cover of the plurality of protective covers 528 is configured to cover a corresponding portion of the at least one corrosion test wire 102 and isolate the at least one corrosion test wire 102 from downhole conditions along a length of the corresponding protective cover 528. For example, a first protective cover 530 may be configured to cover the first corrosion test wire 518 along a first length 532 of the downhole tubular 104, which may extend between the first axial position 114 and a first intermediate position 534. Additionally, a second protective cover 536 may be configured to cover the second corrosion test wire 520 along a second length 538 of the downhole tubular 104, which may extend between the first intermediate position 534 and a second intermediate position 540. Further, a third protective cover 542 may be configured to cover the third corrosion test wire 522 along a third length 544 of the downhole tubular 104, which may extend between the second intermediate position 540 and the second axial position 116. Accordingly, the first protective cover 530 may protect the first corrosion test wire 518 from corrosion along the first length 532 of the downhole tubular 104, the second protective cover 536 may protect the second corrosion test wire 520 from corrosion along the second length 538 of the downhole tubular 104, and the third protective cover 542 may protect the third corrosion test wire 522 from corrosion along the third length 544 of the downhole tubular 104. Using the plurality of corrosion test wires 102 and corresponding protective covers 528, the downhole corrosion detection system 100 may be configured to determine an axial position of the corrosion along the downhole tubular 104.

The measuring device 126 may be configured to measure the ability of each corrosion test wire of the plurality of corrosion test wires 102 to transmit the corresponding electrical signal to determine an amount of corrosion of each corrosion test wire 102. Corrosion of the first corrosion test wire 518 indicates corrosion occurring along the second length 538 and/or third length 544 of the downhole tubular 104 since the first corrosion test wire 518 is covered along the first length 532 by the first protective cover 530. Additionally, corrosion of the second corrosion test wire 520 indicates corrosion occurring along the first length 532 and/or third length 544 of the downhole tubular 104 since the second corrosion test wire 520 is covered along the second length 538 by the second protective cover 536, and corrosion of the third corrosion test wire 522 indicates corrosion occurring along the first length 532 and/or second length 538 of the downhole tubular 104 since the third corrosion test wire 522 is covered along the third length 544 by the third protective cover 542. Accordingly, in response to the measuring device 126 detecting corrosion of the first corrosion test wire 518 and the second corrosion test wire 520, the downhole corrosion detection system 100 may determine that corrosion of the downhole tubular 104 is occurring along the third length 544 of the downhole tubular 104. In another example, in response to the measuring device 126 detecting corrosion of the first corrosion test wire 518 and the third corrosion test wire 522, the downhole corrosion detection system 100 may determine that corrosion of the downhole tubular 104 is occurring along the second length of the downhole tubular 104.

Moreover, each wire of the plurality of corrosion test wires 102 (e.g., the first corrosion test wire 518, the second corrosion test wire 520, the third corrosion test wire 522, etc.) may include the same material. Alternatively, each wire of the plurality of corrosion test wires 102 may include a different material such that the plurality of corrosion test wires 102 have different sensitivities to different corrosion products. For example, the first corrosion test wire 518 may be steel that matches the downhole tubular 104. The second corrosion test wire 520 may be an alloy of magnesium that has accelerated corrosion in acidic fluids and delayed corrosion in alkaline fluids. The third corrosion test wire 522 may be an alloy of aluminum that has accelerated corrosion in both acidic fluids and alkaline fluids but delayed corrosion in neutral pH fluids. By comparing the relative corrosion between the plurality of corrosion test wires 102, the nature of the corrosion, and/or the location of the corrosion may be identified.

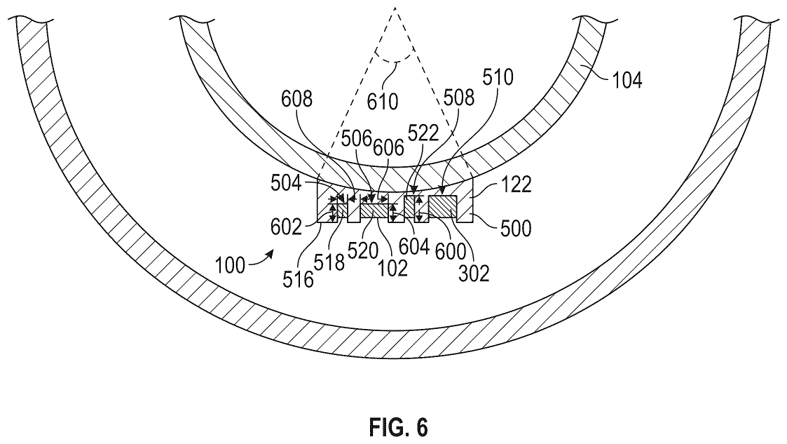

FIG. 6 illustrates an elevation view of a downhole corrosion detection system having unique corrosion test wires, in accordance with some embodiments of the present disclosure. As set forth above, the electrical insulator 122 of the downhole corrosion detection system 100 may include the wire housing 500 having the plurality of recesses 502 (e.g., the first recess 504, the second recess 506, the third recess 508, the fourth recess 510, etc.) each configured to receive a corresponding corrosion test wire 102 or return line 302. The plurality of recesses 502 may be formed in the radially outer surface 516 of the wire housing 500 such that the recesses 502 may be exposed to downhole conditions about the downhole tubular 104. Further, the at least one corrosion test wire 102 may include the plurality of corrosion test wires 102 (e.g., the first corrosion test wire 518, the second corrosion test wire 520, the third corrosion test wire 522, etc.), which may be housed in corresponding recesses 502 of the wire housing 500. The downhole corrosion detection system 100 may also include the return line 302 or the return line may be the tubing 104.

As illustrated, each corrosion test wire of the plurality of corrosion test wires 102 may include a unique cross-sectional area. That is, the sizes and/or shapes of the respective cross-sectional areas of the plurality of corrosion test wires 102 may vary. For example, the first corrosion test wire 518 of the plurality of corrosion test wires 102 includes a smaller cross-sectional area than the second corrosion test wire 520 of the plurality of corrosion test wires 102. Having unique cross-sectional areas for the plurality of corrosion test wires 102 may help provide additional information to the downhole corrosion detection system 100 regarding the severity of corrosion for the downhole tubular 104. For example, the first corrosion test wire 518, which may have a smaller cross-sectional area than the second corrosion test wire 520, may completely corrode before the second corrosion test wire 520 completely corrodes due to the additional material present in the second corrosion test wire 520. Accordingly, the measuring device 126 may detect a greater change in the ability of the first corrosion test wire 518 to transmit the electrical signal than the second corrosion test wire 520. The downhole corrosion detection system 100 may determine that a greater amount of corrosion has occurred to the downhole tubular 104 in response to both the first corrosion test wire 518 and the second corrosion test wire 520 indicating complete corrosion than only the first corrosion test wire 518 indicating complete corrosion.

Moreover, the plurality of corrosion test wires 102 may have a unique radial depths and/or circumferential widths to provide additional information regarding the severity of corrosion for the downhole tubular 104. For example, as illustrated, the third corrosion test wire 522 may include a larger third radial depth 600 than a first radial depth 602 of the first corrosion test wire 518 and a second radial depth 604 of the second corrosion test wire 520. As such, the measuring device 126 detecting complete corrosion of the first corrosion test wire 518 and the second corrosion test wire 520, but not complete corrosion of the third corrosion test wire 522 may provide data to the downhole corrosion detection system regarding a depth of radial corrosion of the downhole tubular 104. That is, the downhole corrosion detection system 100 may determine that corrosion of the downhole tubular 104 has not reached a radial depth of the third corrosion test wire 522. The third corrosion test wire 522 may have a radial depth greater than or equal to a thickness of the downhole tubular 104 such that the downhole corrosion detection system 100 may determine that corrosion has penetrated completely through the downhole tubular 104 in response to the measuring device determining that the third corrosion test wire 522 has completely corroded.

Moreover, as illustrated, the second corrosion test wire 520 may include a larger second width 606 than a first width 608 of the first corrosion test wire 518. As such, the measuring device 126 detecting complete corrosion of the first corrosion test wire 518, but not complete corrosion of the second corrosion test wire 520 may provide data to the downhole corrosion detection system 100 regarding an amount of corrosion of the downhole tubular 104.

Further, as illustrated the wire housing may include a circumferential housing width 610 of between 8-12 degrees. Alternatively, the wire housing 500 may include a circumferential housing width 610 of between 5-15 degrees, or any suitable circumferential housing width 610 up to three-hundred and sixty degrees. That is, the wire housing 500 may encompass the entire circumference of the downhole tubular 104.

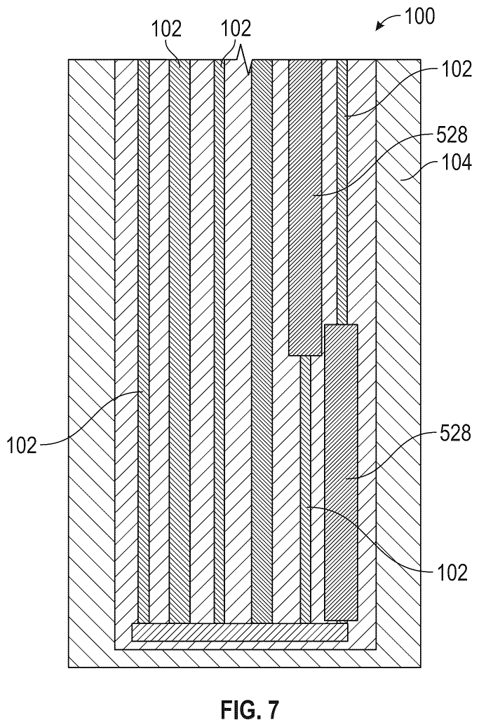

FIG. 7 illustrates an elevation view of a downhole corrosion detection system having a combination of unique corrosion test wires and protective covers, in accordance with some embodiments of the present disclosure. As set forth above, each corrosion test wire of the plurality of corrosion test wires 102 may include a unique cross-sectional area. That is, the sizes and/or shapes of the respective cross-sectional areas of the plurality of corrosion test wires 102 may vary. Having unique cross-sectional areas for the plurality of corrosion test wires 102 may provide information to the downhole corrosion detection system 100 regarding the severity of corrosion for the downhole tubular 104.

Additionally, as set forth above, the downhole corrosion detection system may further include the plurality of protective covers 528 to protect the one or more corresponding corrosion test wires 102 from corrosion. Each protective cover of the plurality of protective covers 528 is configured to cover a corresponding portion of the at least one corrosion test wire 102 and isolate the at least one corrosion test wire 102 from downhole conditions along a length of the corresponding protective cover 528. Further, as set forth above, using the plurality of corrosion test wires 102 and corresponding protective covers 528, the downhole corrosion detection system may be configured to determine an axial position of the corrosion along the downhole tubular 104.

Accordingly, the downhole corrosion detection system may include a combination of combination of unique corrosion test wires 102 and the protective covers 528 to provide information regarding the severity of corrosion for the downhole tubular 104, as well as the axial location of the corrosion.

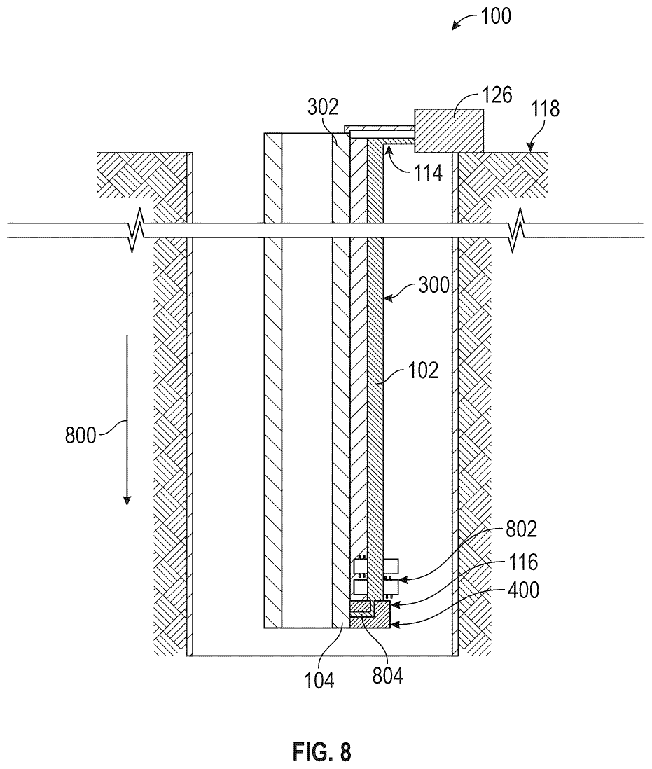

FIG. 8 illustrates an elevation view of a downhole corrosion detection system having an electrical bus with at least one reflector for a pulse reflection measurement, in accordance with some embodiments of the present disclosure. The measuring device 126 of the downhole corrosion detection system 100 may be configured to detect changes in the ability of the at least one corrosion test wire 102 to transmit electrical signals using time-domain reflectometry (TDR) measurement techniques. In particular, the measuring device 126 may determine changes in the ability of the at least one corrosion test wire 102 to transmit electrical signals by observing reflected signals.

For example, the electrical signal may be output proximate the first axial position 114 and travel along the at least one corrosion test wire 102 in a downhole direction 800 toward the electrical bus 400 disposed at the second axial position 116. The electrical signal may include a time-varying electric signal such as an alternating current signal or a pulsed electric signal.

Moreover, at least one reflector 802 disposed proximate the second axial position 116 may be configured to reflect at least a portion of the electrical signal back toward the first axial position 114.

The measuring device 126 may be configured to analyze the reflected signal to determine the waveform of the reflected electrical signal. The reflected signals may be measured and are correlated with a copy of the original electrical signal. Further, the downhole corrosion detection system 100 may employ numerical algorithms to compare the shape and the timing of the signals in order to locate and to identify the discontinuity. Further, the downhole corrosion detection system 100 may be configured to determine the amount of corrosion of the at least one corrosion test wire 102 based at least in part on a waveform of the reflected electrical signal, an amount of time for the reflected electrical signal to arrive, or some combination thereof.

Indeed, discontinuities in the at least one corrosion test wire 102 caused by corrosion may also reflect at least a portion of the electrical signal prematurely. As such, the measuring device 126 may determine that there is a discontinuity or corrosion along the at least one corrosion test wire 102 based on changes in the time for the reflected electrical signal arriving and/or changes in the waveform of the reflected electrical signal. The magnitude, duration, and shape of the reflected waveform can be used to help identify the type and/or location of discontinuity. If there is a step increase in the impedance from corrosion, then the reflected electrical signal will have the same sign as the incident signal. If there is a step decrease in impedance, such as from a short, then the reflected electrical signal will have the opposite sign.

Moreover, an electrical signal may also be applied to the return line 302. For example, a first electrical may be applied to the at least one corrosion test wire 102 and a second electrical signal may be applied to the return line 302 (e.g., the zaftig wire, the downhole tubular 104, a ground plane, etc.). Based on the respective reflected electrical signals, the downhole corrosion detection system 100 may be configured to determine if there are multiple discontinuities along the circuit 300, which may indicate that there is corrosion in multiple locations along the downhole tubular 104.

Additionally, as illustrated, the at least one reflector 802 may be disposed about the at least one corrosion test wire 102 in a position proximate the electrical bus 400. Alternatively, the at least one reflector 802 may be disposed within the electrical bus 400 in a position about a conduit 804 of the electrical bus 400 that is configured to transmit the electrical signal received from the at least one corrosion test wire 102. However, the at least one reflector 802 may be disposed in any suitable position for reflecting at least a portion of the electrical signal.

Moreover, the measuring device of the downhole corrosion detection system 100 may alternatively, or additionally, be configured to detect changes in the ability of the at least one corrosion test wire 102 to transmit electrical signals using Time Domain Transmissometry (TDT) techniques. Instead of measuring the reflected electrical signal as in TDR, Time Domain Transmissometry (TDT) measures the electrical signal that is originally transmitted once is travels through the circuit 300 and returns back to the surface 118. Further, the measuring device of the downhole corrosion detection system 100 may alternatively, or additionally, be configured to detect changes in the ability of the at least one corrosion test wire 102 to transmit electrical signals using Frequency Domain Reflectometry (FDR) techniques. FDR techniques may include transmitting the electrical signal (e.g., a set of stepped-frequency sine waveforms) and measuring changes in frequency spectra, signal amplitudes, phases, or some combination thereof, between the transmitted electrical signal and a return signal (e.g., the reflected electrical signal or the electrical signal once it travels through the circuit 300 and returns to the surface.) The downhole corrosion detection system 100 may be configured to determine the presence and/or amount of corrosion of the at least one corrosion test wire 102 based at least in part on the changes in the frequency spectra, signal amplitudes, phases, or some combination thereof, of the electrical signal. The downhole corrosion detection system 100 may include any suitable technique for detecting changes in the ability of the at least one corrosion test wire 102 to transmit electrical signals.

FIG. 9 illustrates an elevation view of a downhole corrosion detection system with at least one ground plate disposed within a wire housing for a capacitance measurement, in accordance with some embodiments of the present disclosure. The measuring device 126 (shown in FIG. 1) of the downhole corrosion detection system 100 may be configured to detect changes in the ability of the at least one corrosion test wire 102 to transmit electrical signals. Further, the measuring device 126 may be configured to detect changes in the ability of each corrosion test wire of the plurality of corrosion test wires 102 to transmit electrical signals using capacitance measurement techniques.

As set forth above, the electrical insulator 122 of the downhole corrosion detection system may include the wire housing 500 having the plurality of recesses 502 (e.g., the first recess 504, the second recess 506, the third recess 508, the fourth recess 510, a fifth recess 900, etc.) each configured to receive a corresponding corrosion test wire 102 or return line 302. The plurality of recesses 502 may be formed in the radially outer surface 516 of the wire housing 500 such that the recesses 502 may be exposed to downhole conditions about the downhole tubular 104 (shown in FIG. 1). However, at least one recess (e.g., the fifth recess 900) may be covered along at least a portion of the axial length of the downhole tubular 104 for reasons set forth above. Moreover, the at least one corrosion test wire 102 may include the plurality of corrosion test wires 102 (e.g., the first corrosion test wire 518, the second corrosion test wire 520, the third corrosion test wire 522, a fourth corrosion test wire 902, etc.), which may be housed in corresponding recesses 502 of the wire housing 500. The downhole corrosion detection system 100 may also include the return line 302.

The downhole corrosion detection system 100 may further include at least one ground plate 904 disposed within the wire housing 500. The at least one ground plate 904 may extend along the length of the wire housing 500. The at least one ground plate 904 may be run parallel to the at least one corrosion test wire 102 and be configured to function as a ground plane for capacitance measurements. For example, the electrical signal (e.g., an A C signal) may be applied between the at least one corrosion test wire 102 and the at least one ground plate 904 such that the at least one corrosion test wire 102 and the at least one ground plate 904 have a capacitance.

The capacitance (C), can be expressed as:

$$C = {ε}_{o} {ε}_{r} \frac{A}{d}$$

The measuring device 126 may be configured to measure a capacitance between the at least one corrosion test wire 102 and the at least one ground plate 904 to determine the amount of corrosion of the at least one corrosion test wire 102. In particular, the measuring device 126 may detect a base capacitance in response to the at least one corrosion test wire 102 having no corrosion. However, the measuring device 126 may detect a decreased capacitance, with respect to the base capacitance, in response to corrosion of the at least one corrosion test wire 102 because the area of overlap between the at least one corrosion test wire 102 and the at least one ground plate 904 will be reduced due to corrosion. Further, a break in the at least one corrosion test wire 102 and/or a location of the break may be detected based at least in part on the capacitance detected via the measuring device 126.

Further, as illustrated, the at least one ground plate 904 may include a common ground plate 906 and/or a plurality of individual ground plates 908 (e.g., a first ground plate 910 and a second ground plate 912). Each of the common ground plate 906 and the individual ground plates 908 may be disposed between a corresponding recess 502 of the wire housing 500 and an attachment portion 914 of the wire housing 500. The attachment portion 914 is configured to interface with the downhole tubular 104. That is, the attachment portion 914 may be the portion of the wire housing 500 that is in contact with the downhole tubular 104 with the wire housing 500 secured to the downhole tubular 104. Each of the common ground plate 906 and the individual ground plates 908 may be configured to function as a ground planes for capacitance measurements. For example, the first ground plate 910 may be configured to function as a ground plane for the first corrosion test wire 518, the second ground plate 912 may be configured to function as a ground plane for the second corrosion test wire 520, etc.

Additionally, or alternatively, the at least one ground plate 904 may be configured to be the return line 302 of the downhole corrosion detection system 100. For example, capacitance measurements may be used to detect changes in the first corrosion test wire 518 and the second corrosion test wire 520 such that the first ground plate 910 may be configured to function as a ground plane for the first corrosion test wire 518 and the second ground plate 912 may be configured to function as a ground plane for the second corrosion test wire 520. Further, resistance measurements may be used to detect changes in the third corrosion test wire 522 and the fourth corrosion test wire 902 such that the common ground plate 906 may be configured to function as the return line 302 for the third corrosion test wire 522 and the fourth corrosion test wire 902. A ny combination of resistance measurements, capacitance measurements, and time-domain reflectometry (TDR) measurement techniques may be used to detect changes in each corrosion test wire's 102 ability to transmit the electrical signal to detect corrosion in the downhole tubular 104.

Moreover, as set forth above the at least one corrosion test wire 102 may include the multi-strand wire 916 (shown in FIG. 9). Further, at least one strand of the multi-strand wire 916 may be different from other strands of the multi-strand wire 916. For example, the multi-strand wire 916 may include a first strand 918 that matches the corrosion of the downhole tubular 104 and a second strand 920 that is corrosion resistant (shown in FIG. 9).

Accordingly, the present disclosure may provide a downhole corrosion detection system having at least one corrosion detection wire for determining corrosion of a downhole tubular. The systems and methods may include any of the various features disclosed herein, including one or more of the following statements.

Statement 1. A downhole corrosion detection system, comprising: at least one corrosion test wire configured to extend along a downhole tubular at least between a first axial position and a second axial position disposed downhole with respect to the first axial position, wherein the at least one corrosion test wire is configured to transmit an electrical signal; an electrical insulator disposed between the at least one corrosion test wire and the downhole tubular to prevent electrical shorting between the at least one corrosion test wire and the downhole tubular; and a measuring device configured to measure the ability of the at least one corrosion test wire to transmit the electrical signal to determine an amount of corrosion of the at least one corrosion test wire.

Statement 2. The downhole corrosion detection system of statement 1, wherein the corrosion test wire includes a metal material that matches a material corrosion rate of a downhole tubular material of the downhole tubular, wherein the amount of corrosion of the at least one corrosion test wire is indicative of the amount of corrosion of the downhole tubular.

Statement 3. The downhole corrosion detection system of statement 1 or statement 2, wherein a metal wire material of the at least one corrosion test wire matches a tensile strength, grain size, heat treatment, electrochemical potential, a corrosion rate of a downhole tubular material of the downhole tubular, or some combination thereof.

Statement 4. The downhole corrosion detection system of any preceding statement, further comprising an electrical bus disposed at the second axial position, wherein the at least one corrosion test wire is coupled to the electrical bus.

Statement 5. The downhole corrosion detection system of any preceding statement, further comprising a return line extending along the downhole tubular, wherein a first end of the return line is coupled to the electrical bus and a second end of the return line is coupled to the measuring device, wherein return line is configured to transmit the electrical signal between the electrical bus and the measuring device.

Statement 6. The downhole corrosion detection system of any of statements 1-4, wherein the electrical bus is electrically coupled to the downhole tubular, wherein the measuring device is electrically coupled to the downhole tubular, and wherein the downhole tubular is configured to transmit the electrical signal between the electrical bus and the measuring device.

Statement 7. The downhole corrosion detection system of any preceding statement, further comprising a power source configured to apply the electrical signal at the first axial position, wherein the electrical signal includes a voltage applied to the at least one corrosion test wire at the first axial position, and wherein the measuring device is configured to perform a resistance measurement to determine the amount of corrosion of the at least one corrosion test wire.

Statement 8. The downhole corrosion detection system of any preceding statement, further comprising an electrical bus having at least one reflector configured to reflect the electrical signal, wherein the at least one corrosion test wire is configured to transmit a reflected electrical signal from the electrical bus to the measuring device, and wherein the measuring device is configured to determine the amount of corrosion of the at least one corrosion test wire based at least in part on a waveform of the reflected electrical signal, an amount of time for the reflected electrical signal to arrive, or some combination thereof.

Statement 9. The downhole corrosion detection system of any preceding statement, wherein the electrical insulator includes an electrically insulative material, wherein the electrically insulative material includes polymer, rubber, ceramic, glass, or some combination thereof.

Statement 10. The downhole corrosion detection system of any preceding statement, wherein the electrical insulator includes a wire housing having at least one recess configured to receive the at least one corrosion test wire.

Statement 11. The downhole corrosion detection system of any preceding statement, further comprising at least one ground plate disposed within the wire housing, wherein the at least one ground plate is disposed between the at least one recess and an attachment portion of the wire housing, wherein the attachment portion is configured to interface with the downhole tubular.

Statement 12. The downhole corrosion detection system of any preceding statement, wherein the measuring device is configured to measure a capacitance between the at least one corrosion test wire and the at least one ground plate to determine the amount of corrosion of the at least one corrosion test wire.

Statement 13. The downhole corrosion detection system of any preceding statement, wherein the at least one corrosion test wire includes a plurality of corrosion test wires, wherein the wire housing includes individual recesses corresponding to each corrosion test wire of the plurality of corrosion test wires, wherein the individual recesses are configured to prevent electrical shorting between the plurality of corrosion test wires.

Statement 14. The downhole corrosion detection system of any preceding statement, further comprising a plurality of protective covers, wherein each protective cover of the plurality of protective covers is configured to cover a corresponding portion of the at least one corrosion test wire and isolate the at least one corrosion test wire from downhole conditions along a length of the corresponding protective cover, wherein a first protective cover extends along a first length of the downhole tubular, and wherein a second protective cover extends along a second length of the downhole tubular.

Statement 15. The downhole corrosion detection system of any preceding statement, wherein the at least one corrosion test wire includes a plurality of corrosion test wires, wherein each corrosion test wire of the plurality of corrosion test wires includes a unique cross-sectional area, wherein a first corrosion test wire of the plurality of corrosion test wires includes a smaller cross-sectional area than a second corrosion test wire of the plurality of corrosion test wires.

Statement 16. The downhole corrosion detection system of any preceding statement, wherein the at least one corrosion test wire includes a plurality of corrosion test wires, wherein a first corrosion test wire of the plurality of corrosion test wires includes a larger radial depth than a second corrosion test wire of the plurality of corrosion test wires.

Statement 17. The downhole corrosion detection system of any preceding statement, wherein the at least one corrosion test wire includes a plurality of corrosion test wires, wherein a first corrosion test wire of the plurality of corrosion test wires includes a larger circumferential width than a second corrosion test wire of the plurality of corrosion test wires.

Statement 18. A downhole corrosion detection system, comprising: a plurality of corrosion test wires configured to extend along a downhole tubular at least between a first axial position and a second axial position disposed downhole with respect to the first axial position, wherein each corrosion test wire of the plurality of corrosion test wires is configured to transmit a corresponding electrical signal applied at the first axial position, and wherein a first corrosion test wire of the plurality of corrosion test wires includes a unique cross-sectional shape with respect to a second corrosion test wire of the plurality of corrosion test wires; an electrical insulator disposed between the plurality of corrosion test wires and the downhole tubular to prevent electrical shorting between the plurality of corrosion test wires and the downhole tubular, wherein the electrical insulator includes a wire housing having individual recesses corresponding to each corrosion test wire of the plurality of corrosion test wires, wherein the individual recesses are configured to prevent electrical shorting between the plurality of corrosion test wires; and a measuring device configured to measure the ability of each corrosion test wire of the plurality of corrosion test wires to transmit the corresponding electrical signal to determine an amount of corrosion of each corrosion test wire of the plurality of corrosion test wires.

Statement 19. The downhole corrosion detection system of statement 18, further comprising a first protective cover and a second protective cover, wherein the first protective cover is configured to cover a corresponding portion of the first corrosion test wire and the second protective cover is configured to cover a corresponding portion of the second corrosion test wire, and wherein the first protective cover extends along a first length of the downhole tubular and the second protective cover extends along a second length of the downhole tubular.

Statement 20. A downhole corrosion detection system, comprising: a plurality of corrosion test wires configured to extend along a downhole tubular at least between a first axial position and a second axial position disposed downhole with respect to the first axial position, wherein each corrosion test wire of the plurality of corrosion test wires is configured to transmit a corresponding electrical signal applied at the first axial position; an electrical insulator disposed between the plurality of corrosion test wires and the downhole tubular to prevent electrical shorting between the plurality of corrosion test wires and the downhole tubular, wherein the electrical insulator includes a wire housing having individual recesses corresponding to each corrosion test wire of the plurality of corrosion test wires, wherein the individual recesses are configured to prevent electrical shorting between the plurality of corrosion test wires; at first protective cover configured to cover a first corrosion test wire along a first length of the downhole tubular; at second protective cover configured to cover a second corrosion test wire along a second length of the downhole tubular; and a measuring device configured to measure the ability of each corrosion test wire of the plurality of corrosion test wires to transmit the corresponding electrical signal to determine an amount of corrosion of each corrosion test wire of the plurality of corrosion test wires, wherein corrosion of the first corrosion test wire indicates corrosion occurring along the second length of the downhole tubular, and wherein corrosion of the second corrosion test wire indicates corrosion along the first length of the downhole tubular.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A downhole corrosion detection system, comprising:
at least one corrosion test wire configured to extend along a downhole tubular at least between a first axial position and a second axial position disposed downhole with respect to the first axial position, wherein the at least one corrosion test wire is configured to transmit an electrical signal;
an electrical insulator disposed between the at least one corrosion test wire and the downhole tubular to prevent electrical shorting between the at least one corrosion test wire and the downhole tubular; and
a measuring device configured to measure the ability of the at least one corrosion test wire to transmit the electrical signal to determine an amount of corrosion of the at least one corrosion test wire.

2. The downhole corrosion detection system of claim 1, wherein the corrosion test wire includes a metal material that matches a material corrosion rate of a downhole tubular material of the downhole tubular, wherein the amount of corrosion of the at least one corrosion test wire is indicative of the amount of corrosion of the downhole tubular.

3. The downhole corrosion detection system of claim 1, wherein a metal wire material of the at least one corrosion test wire matches a tensile strength, grain size, heat treatment, electrochemical potential, a corrosion rate of a downhole tubular material of the downhole tubular, or some combination thereof.

4. The downhole corrosion detection system of claim 1, further comprising an electrical bus disposed at the second axial position, wherein the at least one corrosion test wire is coupled to the electrical bus.

5. The downhole corrosion detection system of claim 4, further comprising a return line extending along the downhole tubular, wherein a first end of the return line is coupled to the electrical bus and a second end of the return line is coupled to the measuring device, wherein return line is configured to transmit the electrical signal between the electrical bus and the measuring device.

6. The downhole corrosion detection system of claim 4, wherein the electrical bus is electrically coupled to the downhole tubular, wherein the measuring device is electrically coupled to the downhole tubular, and wherein the downhole tubular is configured to transmit the electrical signal between the electrical bus and the measuring device.

7. The downhole corrosion detection system of claim 1, further comprising a power source configured to apply the electrical signal at the first axial position, wherein the electrical signal includes a voltage applied to the at least one corrosion test wire at the first axial position, and wherein the measuring device is configured to perform a resistance measurement to determine the amount of corrosion of the at least one corrosion test wire.

8. The downhole corrosion detection system of claim 1, further comprising an electrical bus having at least one reflector configured to reflect the electrical signal, wherein the at least one corrosion test wire is configured to transmit a reflected electrical signal from the electrical bus to the measuring device, and wherein the measuring device is configured to determine the amount of corrosion of the at least one corrosion test wire based at least in part on a waveform of the reflected electrical signal, an amount of time for the reflected electrical signal to arrive, or some combination thereof.

9. The downhole corrosion detection system of claim 1, wherein the electrical insulator includes an electrically insulative material, wherein the electrically insulative material includes polymer, rubber, ceramic, glass, or some combination thereof.

10. The downhole corrosion detection system of claim 1, wherein the electrical insulator includes a wire housing having at least one recess configured to receive the at least one corrosion test wire.

11. The downhole corrosion detection system of claim 10, further comprising at least one ground plate disposed within the wire housing, wherein the at least one ground plate is disposed between the at least one recess and an attachment portion of the wire housing, wherein the attachment portion is configured to interface with the downhole tubular.

12. The downhole corrosion detection system of claim 11, wherein the measuring device is configured to measure a capacitance between the at least one corrosion test wire and the at least one ground plate to determine the amount of corrosion of the at least one corrosion test wire.

13. The downhole corrosion detection system of claim 10, wherein the at least one corrosion test wire includes a plurality of corrosion test wires, wherein the wire housing includes individual recesses corresponding to each corrosion test wire of the plurality of corrosion test wires, wherein the individual recesses are configured to prevent electrical shorting between the plurality of corrosion test wires.

14. The downhole corrosion detection system of claim 1, further comprising a plurality of protective covers, wherein each protective cover of the plurality of protective covers is configured to cover a corresponding portion of the at least one corrosion test wire and isolate the at least one corrosion test wire from downhole conditions along a length of the corresponding protective cover, wherein a first protective cover extends along a first length of the downhole tubular, and wherein a second protective cover extends along a second length of the downhole tubular.

15. The downhole corrosion detection system of claim 1, wherein the at least one corrosion test wire includes a plurality of corrosion test wires, wherein each corrosion test wire of the plurality of corrosion test wires includes a unique cross-sectional area, wherein a first corrosion test wire of the plurality of corrosion test wires includes a smaller cross-sectional area than a second corrosion test wire of the plurality of corrosion test wires.

16. The downhole corrosion detection system of claim 1, wherein the at least one corrosion test wire includes a plurality of corrosion test wires, wherein a first corrosion test wire of the plurality of corrosion test wires includes a larger radial depth than a second corrosion test wire of the plurality of corrosion test wires.

17. The downhole corrosion detection system of claim 1, wherein the at least one corrosion test wire includes a plurality of corrosion test wires, wherein a first corrosion test wire of the plurality of corrosion test wires includes a larger circumferential width than a second corrosion test wire of the plurality of corrosion test wires.

18. A downhole corrosion detection system, comprising:
a plurality of corrosion test wires configured to extend along a downhole tubular at least between a first axial position and a second axial position disposed downhole with respect to the first axial position, wherein each corrosion test wire of the plurality of corrosion test wires is configured to transmit a corresponding electrical signal applied at the first axial position, and wherein a first corrosion test wire of the plurality of corrosion test wires includes a unique cross-sectional shape with respect to a second corrosion test wire of the plurality of corrosion test wires;
an electrical insulator disposed between the plurality of corrosion test wires and the downhole tubular to prevent electrical shorting between the plurality of corrosion test wires and the downhole tubular, wherein the electrical insulator includes a wire housing having individual recesses corresponding to each corrosion test wire of the plurality of corrosion test wires, wherein the individual recesses are configured to prevent electrical shorting between the plurality of corrosion test wires; and
a measuring device configured to measure the ability of each corrosion test wire of the plurality of corrosion test wires to transmit the corresponding electrical signal to determine an amount of corrosion of each corrosion test wire of the plurality of corrosion test wires.

19. The downhole corrosion detection system of claim 18, further comprising a first protective cover and a second protective cover, wherein the first protective cover is configured to cover a corresponding portion of the first corrosion test wire and the second protective cover is configured to cover a corresponding portion of the second corrosion test wire, and wherein the first protective cover extends along a first length of the downhole tubular and the second protective cover extends along a second length of the downhole tubular.

20. A downhole corrosion detection system, comprising:
a plurality of corrosion test wires configured to extend along a downhole tubular at least between a first axial position and a second axial position disposed downhole with respect to the first axial position, wherein each corrosion test wire of the plurality of corrosion test wires is configured to transmit a corresponding electrical signal applied at the first axial position;
an electrical insulator disposed between the plurality of corrosion test wires and the downhole tubular to prevent electrical shorting between the plurality of corrosion test wires and the downhole tubular, wherein the electrical insulator includes a wire housing having individual recesses corresponding to each corrosion test wire of the plurality of corrosion test wires, wherein the individual recesses are configured to prevent electrical shorting between the plurality of corrosion test wires;
at first protective cover configured to cover a first corrosion test wire along a first length of the downhole tubular;
at second protective cover configured to cover a second corrosion test wire along a second length of the downhole tubular; and
a measuring device configured to measure the ability of each corrosion test wire of the plurality of corrosion test wires to transmit the corresponding electrical signal to determine an amount of corrosion of each corrosion test wire of the plurality of corrosion test wires, wherein corrosion of the first corrosion test wire indicates corrosion occurring along the second length of the downhole tubular, and wherein corrosion of the second corrosion test wire indicates corrosion along the first length of the downhole tubular.
